(19) United States
(12) Patent Application Publication
(10) Pub. No.: US 2023/0177781 A1
(43) Pub. Date: Jun. 8, 2023

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: HAJIME WAKABAYASHI, TOKYO (JP)

(21) Appl. No.: 17/906,647

(22) PCT Filed: Mar. 5, 2021
(86) PCT No.: PCT/JP2021/008762

§ 371 Date: Sep. 19, 2022

(30) Foreign Application Priority Data
Mar. 31, 2020 (JP) 2020-062045

(51) Int. Cl. G06T 19/00; G06T 19/20

(52) U.S. Cl. CPC G06T 19/006; G06T 19/20; G06T 2210/21; G06T 2219/2016

(57) ABSTRACT

An information processing apparatus (1) according to an aspect of an embodiment includes a setting unit (6b) and an allocation unit (6c). In a virtual space displayed on a display unit (4), the setting unit (6b) sets a collider for collision determination, which is allocated to mesh data indicating a shape of a real object present in a real world, to a size different from the size of the mesh data. The allocation unit (6c) allocates the collider corresponding to the size set by the setting unit (6b) to the mesh data.

### FIELD

The present invention relates to an information processing apparatus, an information processing method, and an information processing program.

### BACKGROUND

In recent years, a technology for providing a user with augmented reality for superimposing and displaying a virtual object on a display has been widespread. An information processing apparatus that provides augmented reality specifies, based on, for example, a visual line of the user, a virtual object present in a virtual space selected by a user.

For example, there is a technique for estimating a visual line from movement of eyeballs of a user and specifying, as a virtual object selected by the user, a virtual object present in a region obtained by expanding the estimated visual line in a conical shape (see, for example, Patent Document 1.).

### CITATION LIST

### Patent Literature

Patent Literature 1: JP 2019-517049 W

### SUMMARY

### Technical Problem

However, in the related art, there is room for improvement in terms of improving the operability of the user. Specifically, in the related art, since a selectable region is expanded, for example, when a plurality of virtual objects are present adjacent to one another, there is a risk of inducing erroneous operation.

The present invention has been made in view of the above, and an object of the present invention is to provide an information processing apparatus, an information processing method, and an information processing program that can improve operability of a user.

### Solution to Problem

To solve the above-mentioned problems and achieve the purpose, an information processing apparatus according to an aspect of an embodiment includes a setting unit and an allocation unit. In a virtual space displayed on a display unit, the setting unit sets a collider for collision determination, which is allocated to mesh data indicating a shape of a real object present in a real world, to a size different from the size of the mesh data. The allocation unit allocates the collider corresponding to the size set by the setting unit to the mesh data.

### Advantageous Effects of Invention

According to one aspect of the embodiment, the operability of the user can be improved.

### BRIEF DESCRIPTION OF DRAWINGS

FIG. 1 is a diagram illustrating an overview of an information processing apparatus according to an embodiment.

FIG. 2 is a diagram illustrating an overview of the information processing apparatus according to the embodiment.

FIG. 3 is a block diagram of an information processing apparatus according to the embodiment.

FIG. 4 is a diagram illustrating a specific example of selection operation according to the embodiment.

FIG. 5 is a diagram for explaining an example of parameters concerning a setting coefficient.

FIG. 6 is a diagram for explaining an example of parameter concerning a setting coefficient.

FIG. 7 is a flowchart illustrating a processing procedure executed by the information processing apparatus according to the embodiment.

FIG. 8 is a flowchart illustrating a processing procedure executed by the information processing apparatus according to the embodiment.

FIG. 9 is a schematic diagram illustrating a relationship between a shielding mesh and a collider.

FIG. 10 is a hardware configuration diagram illustrating an example of a computer that realizes functions of an information processing apparatus.

### DESCRIPTION OF EMBODIMENTS

An embodiment of the present disclosure is explained in detail below with reference to the drawings. Note that, in the embodiments explained below, redundant explanation is omitted by denoting the same parts with the same reference numerals and signs.

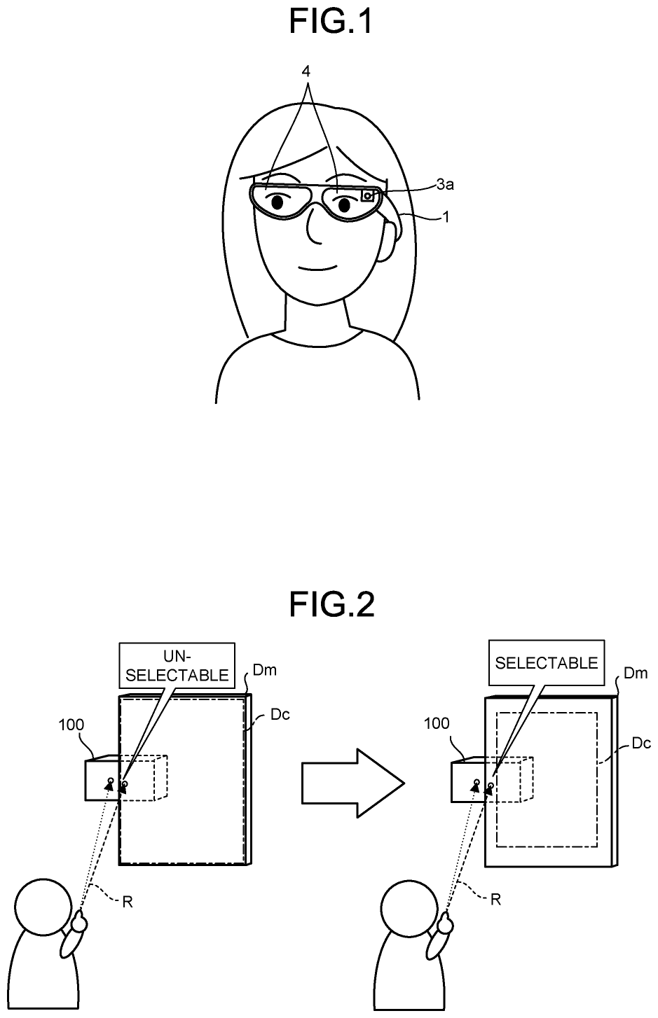

First, an overview of an information processing apparatus according to an embodiment is explained with reference to FIG. 1 and FIG. 2. FIG. 1 and FIG. 2 are diagrams illustrating the overview of the information processing apparatus.

In an example illustrated in FIG. 1, an information processing apparatus 1 is an augmented reality (AR) device that provides AR and is a head mounted display (HMD).

The information processing apparatus 1 is a so-called optical see-through type HMD that includes an optically transmissive display unit 4 and displays, on the display unit 4, a virtual object present in a virtual space. The information processing apparatus 1 may be a video see-through type AR device that superimposes and displays a virtual object superimposed on a video imaged by an outward camera 3a that images a front region of the display unit 4.

The information processing apparatus 1 controls the disposition, the shape, and the like of the virtual object based on information concerning a real space obtained by imaging by the outward camera 3a, for example, information concerning the position and the shape of an object present in the real space.

Specifically, the information processing apparatus 1 recognizes various objects (hereinafter described as real object) such as walls present in the real space and, for example, generates three-dimensional mesh data indicating the shape of the real object, and allocates a collider to the mesh data. Note that, in the following explanation, the mesh data indicating the shape of the real object is described as “shielding mesh”.

Here, the collider is three-dimensional data for collision determination with respect to the shielding mesh. Usually, a collider having the same shape (size) as the shielding mesh is allocated to the shielding mesh. Note that the collider is allocated to the virtual object in the same manner as being allocated to the shielding mesh.

For example, the information processing apparatus 1 receives selection operation of the user for a virtual object and specifies the virtual object selected by the selection operation. For example, as explained below with reference to FIG. 2, the information processing apparatus 1 recognizes, as the selection operation, a gesture of the user pointing a virtual object with a finger and virtually emits a ray (hereinafter described as ray R) from the finger of the user in a direction pointed by the finger. The information processing apparatus 1 specifies a virtual object colliding with the ray R first in the virtual space as the virtual object selected by the user.

At this time, for example, as illustrated in a left diagram of FIG. 2, it is assumed that the user performs selection operation on a virtual object 100 under a situation where a part of the virtual object 100 is shielded by a shielding mesh Dm when viewed from the user.

In this case, a starting point of the ray R and a direction of the ray R sometimes deviates from a true value because of an error in the selection operation by the user, recognition accuracy of the selection operation by the information processing apparatus 1, or the like. At this time, as illustrated in the left diagram of FIG. 2, when the ray R collides with a collider Dc allocated to the shielding mesh Dm, since the virtual object 100 cannot be selected by the selection operation performed by the user on the virtual object 100, operability is deteriorated.

Accordingly, in the information processing apparatus 1 according to the embodiment, the size of the collider Dc allocated to the shielding mesh Dm is set and, then, the collider Dc is allocated to the shielding mesh Dm.

For example, as illustrated in a right diagram of FIG. 2, in the information processing apparatus 1, the size of the collider Dc is set slightly smaller than the shielding mesh Dm and the collider Dc having the set size is allocated to the shielding mesh Dm.

Consequently, even in a case where an error occurs in the ray R, since the ray R allocated to the shielding mesh Dm does not collide with the collider Dc, the ray R penetrates the shielding mesh Dm and collides with the virtual object 100.

That is, in the information processing apparatus 1, the selectable area of the virtual object 100 can be substantially expanded by forming the collider Dc smaller than the shielding mesh Dm.

As explained above, in the information processing apparatus 1 according to the embodiment, since the user's selection operation for the virtual object 100 shielded by the shielding mesh Dm can be facilitated, the operability of the user can be improved.

In the example explained above, the case where the collider Dc is set small with respect to the shielding mesh Dm is explained. However, the present invention is not limited thereto. That is, the collider Dc may be set large with respect to the shielding mesh Dm. A specific example of this point is explained below with reference to FIG. 9.

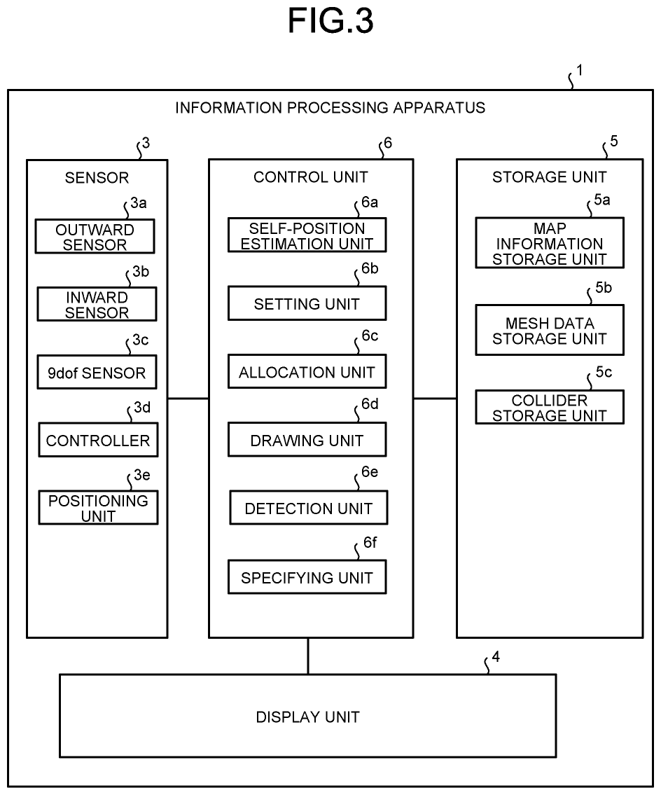

Next, a configuration example of the information processing apparatus 1 according to the embodiment is explained with reference to FIG. 3. FIG. 3 is a block diagram of the information processing apparatus 1 according to the embodiment. In an example illustrated in FIG. 3, the information processing apparatus 1 includes a sensor 3, a display unit 4, a storage unit 5, and a control unit 6.

The sensor 3 includes an outward camera 3a, an inward camera 3b, a 9 degrees of freedom (dof) sensor 3c, a controller 3d, and a positioning unit 3e. Note that the configuration of the sensor 3 illustrated in FIG. 3 is an example and does not particularly needs to be limited to the configuration illustrated in FIG. 3. For example, besides the units illustrated in FIG. 3, the sensor 3 may include various sensors such as environment sensors such as an illuminance sensor and a temperature sensor, an ultrasonic sensor, and an infrared sensor. Each of the sensors may be a single sensor or may be a plurality of sensors.

The outward camera 3a captures a video around the user in the real space. It is desirable that the angle of view and the direction of the outward camera 3a be set such that the outward camera 3a images the direction of the user's face in the real space when being worn. A plurality of outward cameras 3a may be provided. Further, the outward camera 3a may include a depth sensor.

The outward camera 3a includes, for example, a lens system, a drive system, and an individual imaging element array. The lens system includes an imaging lens, a diaphragm, a zoom lens, and a focus lens. The drive system causes the lens system to perform a focusing operation and a zooming operation. The solid-state imaging element array photoelectrically converts imaging light obtained by the lens system to generate an imaging signal. The solid-state imaging element array can be implemented by, for example, a Charge Coupled Device (CCD) or a Complementary Metal Oxide Semiconductor (CMOS).

The inward camera 3b images the eyeballs of the user wearing the information processing apparatus 1. Therefore, it is preferable that the inward camera 3b be provided to be directed to the user's face (particularly, eyes). Like the outward camera 3a, the inward camera 3b includes a lens system, a drive system, and a fixed imaging element array. Note that a depth sensor or a Dynamic Vision Sensor (DVS) may be provided in order to detect the user's eyeballs.

The 9 dof sensor 3c acquires information for estimating a relative self-position and a posture of the user (the information processing apparatus 1). The 9 dof sensor 3c is an inertial measurement device with nine degrees of freedom and is configured by a three-axis acceleration sensor, a three-axis gyro sensor, and a three-axis geomagnetic sensor. The 9 dof sensor 3c detects acceleration acting on the user (the information processing apparatus 1), angular velocity (rotation speed) acting on the user (the information processing apparatus 1), and absolute orientation of the user (the information processing apparatus 1).

The controller 3d is, for example, an operation device held by the user. The controller 3d includes, for example, a 9 dof sensor and an operation button. The user can perform selection operation for the virtual object 100 displayed on the display unit 4 by operating the posture of the controller 3d or the operation button. Note that, for example, when the information processing apparatus 1 is a video see-through type AR device such as a smartphone, the information processing apparatus 1 itself can function as a controller.

The positioning unit 3e acquires the current position (absolute position) of the user (the information processing apparatus 1) with a positioning function. For example, the positioning unit 3e can have a positioning function for acquiring information concerning the current position of the user (the information processing apparatus 1) based on an acquired signal from the outside. The positioning unit 3e can measure the current position of the user (the information processing apparatus 1), for example, based on a radio wave signal received from a Global Navigation Satellite System (GNSS) satellite. The positioning unit 3e can also use an acquired signal from a Global Positioning System (GPS), Beidou, a Quasi-Zenith Satellite System (QZSS), Galileo, or an Assisted Global Positioning System (A-GPS). Information acquired by the positioning unit 3e can include information related to latitude, longitude, altitude, and a positioning error. Information acquired by the positioning function may be coordinates of an X axis, a Y axis, and a Z axis having a specific geographic position as an origin and may include information indicating outdoor or indoor together with the coordinates. The positioning unit 3e may have a function of detecting the current position of the user (the information processing apparatus 1), for example, through transmission and reception to and from communication equipment such as Wi-Fi (registered trademark), Bluetooth (registered trademark), or a smartphone, near field communication, or the like.

The display unit 4 has a display surface configured by, for example, a half mirror or a transmissive light guide plate. The display unit 4 causes the user to view a video by projecting the video (light) from the inside of the display surface toward the eyeballs of the user.

The storage unit 5 stores programs and data used to realize various functions of the information processing apparatus 1. The storage unit 5 is realized by, for example, a semiconductor memory element such as a Random Access Memory (RAM) or a flash memory or a storage device such as a hard disk or an optical disk. The storage unit 5 is also used to store parameters used in various kinds of processing and is used as, for example, a work area for various kinds of processing.

In the example illustrated in FIG. 3, the storage unit 5 includes a map information storage unit 5a, a mesh data storage unit 5b, and a collider storage unit 5c. The map information storage unit 5a is a storage region that stores map information indicating a peripheral environment in the real space.

The mesh data storage unit 5b is a storage region that stores the shielding mesh Dm indicating the shape of each real object present in the real space. The collider storage unit 5c is a storage region that stores the collider Dc allocated to the shielding mesh Dm. For example, the collider storage unit 5c stores a plurality of colliders Dc having different sizes for each shielding mesh Dm.

The control unit 6 controls various kinds of processing executed in the information processing apparatus 1. The control unit 6 is realized by, for example, various programs stored in the storage device on the inside of the information processing apparatus 1 being executed by a Central Processing Unit (CPU), a Micro Processing Unit (MPU), or the like using a RAM as a work region. The control unit 6 is realized by, for example, an integrated circuit such as an Application Specific Integrated Circuit (ASIC) or a Field Programmable Gate Array (FPGA). The control unit 6 includes a self-position estimation unit 6a, a setting unit 6b, an allocation unit 6c, a drawing unit 6d, a detection unit 6e, and a specifying unit 6f.

The self-position estimation unit 6a estimates a self-position of the user (the information processing apparatus 1). For example, the self-position estimation unit 6a simultaneously performs creation of an environmental map and estimation of the self-position using a Simultaneous Localization And Mapping (SLAM) method based on a video captured by the outward camera 3a. Note that the self-position estimation unit 6a estimates the self-position including the current posture of the user (the information processing apparatus 1).

The environmental map created by the self-position estimation unit 6a is stored in the map information storage unit 5a as map information. Incidentally, according to the movement of the information processing apparatus 1, errors included in the self-position estimated by the self-position estimation unit 6a accumulate.

Accordingly, the self-position estimation unit 6a corrects the self-position at a predetermined cycle. For example, the self-position estimation unit 6a corrects the self-position using any method such as correction by an AR marker.

Note that the self-position estimation unit 6a may perform the creation of the environmental map and estimation of the self-position using a Visual Inertial Odemetry (VIO) method based on a measurement result of the 9 dof sensor 3c in addition to a video imaged by the outward camera 3a.

In the virtual space displayed on the display unit 4, the setting unit 6b sets the collider Dc for collision determination, which is allocated to the shielding mesh Dm (see FIG. 2) indicating the shape of the real object present in the real world, to a size different from the size of the shielding mesh Dm.

Specifically, first, the setting unit 6b reads the virtual object 100 and the shielding mesh Dm, which are likely to be displayed on the display unit 4, based on a self-position estimation result by the self-position estimation unit 6a.

Subsequently, when the virtual object 100 shielded by the shielding mesh Dm is present, the setting unit 6b proceeds to processing for setting the size of the collider Dc allocated to the shielding mesh Dm.

The setting processing for the collider Dc by the setting unit 6b is performed by calculating the setting coefficient C. Here, the setting coefficient C is a coefficient concerning specifying accuracy for a selected object by the specifying unit 6f explained below (hereinafter simply described as “specifying accuracy”) and is a coefficient indicating a degree of reducing the collider Dc allocated to the shielding mesh Dm.

For example, as the assumed specifying accuracy is lower, the setting coefficient C is a larger value and the collider Dc is smaller with respect to the shielding mesh Dm. If the assumed specifying accuracy is sufficient, the setting coefficient C has a small value and the collider Dc has the a size equivalent to the shielding mesh Dm.

That is, when the specifying accuracy is sufficient, the setting unit 6b sets the collider Dc to substantially the same size as the shielding mesh Dm and, as the specifying accuracy decreases, sets the collider Dc smaller with respect to the shielding mesh Dm.

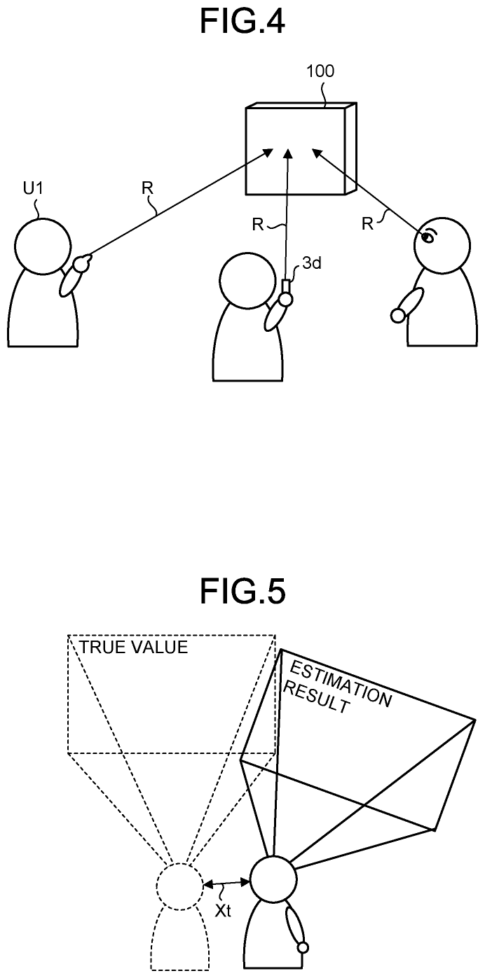

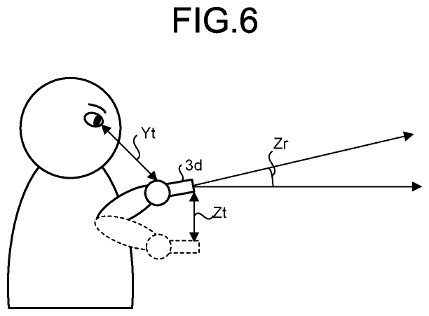

Here, a series of processing by the setting unit 6b is explained with reference to FIG. 4 to FIG. 6. FIG. 4 is a diagram illustrating a specific example of the selection operation according to the embodiment. FIG. 5 and FIG. 6 are diagrams for explaining an example of parameters concerning the setting coefficient C.

As illustrated in FIG. 4, the information processing apparatus 1 detects different types of selection operation. Specifically, the information processing apparatus 1 detects selection operation by finger pointing, selection operation by the controller 3d, and selection operation by a visual line in order from the left in FIG. 4.

Subsequently, various parameters in estimating the specifying accuracy is explained with reference to FIG. 5 and FIG. 6. For example, as illustrated in FIG. 5, the setting unit 6b calculates a first distance parameter Xt due to an estimation error caused by a self-position estimation result by the self-position estimation unit 6a.

The first distance parameter Xt is a parameter concerning an error of a distance that can be included in the self-position estimated by the self-position estimation unit 6a. For example, if it is assumed that an error of 5 cm is included every time the self-position moves by 1 m, the first distance parameter Xt is calculated as a movement amount (m)×0.05.

Here, as explained above, since the self-position estimation unit 6a corrects the self-position at the predetermined cycle, the self-position estimation result is corrected to a value close to the true value. Accordingly, the movement amount explained above is reset to “0” every time the self-position is corrected.

Furthermore, an error concerning a rotation amount can be included in the self-position estimation result in addition to the error concerning the distance. If it assumed that a parameter of the error concerning the rotation amount is represented as a first rotation parameter Xy and an error of 3.6 deg is included every time the movement amount rotates by 360 deg, the first rotation parameter Xy is the rotation amount (deg)×0.01. Note that, like the movement amount explained above, the rotation amount used to calculate the first rotation parameter Xy is reset to “0” every time the self-position is corrected.

As explained above, in setting the size of the collider Dc, by considering the error included in the self-position, by reducing the collider Dc, it is possible to compensate for a decrease in the specifying accuracy due to deviation of a display position of the virtual object 100 displayed on the display unit 4.

As illustrated in FIG. 6, a starting point parameter Yt corresponding to the distance from a starting point of the selection operation to the eyes of the user and a second distance parameter Zt and a second rotation parameter Zr concerning shaking of the selection operation are included in the parameters concerning the setting coefficient C.

The starting point parameter Yt is a parameter due to the distance between the user's eyes and the starting point of the selection operation. In an example illustrated in FIG. 6, the controller 3d is the starting point of the selection operation and, as the controller 3d moves farther away from the user's eyes, the position of the user's eyes and the starting point of the selection operation (the starting point of the ray R) are farther away.

Accordingly, even if the user can visually recognize the virtual object 100 via the display unit 4, in some case, the ray R by actual selection operation collides with the collider Dc of the shielding mesh Dm that shields the virtual object 100 and the virtual object 100 cannot be selected.

That is, as the distance from the user's eyes to the controller 3d increases, intuitive selection operation for the virtual object 100 displayed on the display unit 4 and the actual ray R more easily deviate from each other. Accordingly, the starting point parameter Yt is a parameter for correcting the deviation. Note that, in a case where the user performs a selection operation by a visual line, the value of the starting point parameter Yt is “0”.

Even when the controller 3d vibrates, for example, during walking of the user, that is, when the starting point of the selection operation vibrates, it is assumed that the user's selection operation and the actual ray R easily diverge from each other. Accordingly, the setting coefficient C preferably takes into consideration a vibration component of the starting point of the selection operation by the user.

For example, a value obtained by multiplying the maximum swing width of a high-frequency component (for example, 3 Hz or more) included in displacement of the starting point of the selection operation within a certain period of time by a predetermined coefficient is calculated as the second distance parameter Zt and a value obtained by multiplying the maximum rotation amount of the starting point of the selection operation by a predetermined coefficient is calculated as the second rotation parameter Zr. Note that the predetermined coefficient here is usually “1” but may be set by the user as appropriately. The threshold value (corresponding to the 3 Hz described above) regarding the high frequency component may also be set according to a situation or the like used by the user.

The selection operation by the controller 3d is explained as an example above. However, the same applies to selection operation by a visual line and a finger. Besides, as parameters of the setting coefficient C, a third distance parameter Wt and a third rotation parameter Wr due to a recognition error of the controller 3d and an error of a recognition device in image recognition of a visual line or a finger may be included.

For example, the setting unit 6b calculates the setting coefficient C with the following (Expression 1) using the parameters explained above.

[Math. 1]

C=Xt+Yt+Zt+Wt+L tan(Xr+Zr+Wr) (Expression 1)

Note that, in (Expression 1), “L” indicates the distance to the virtual object 100 most distant viewed from the user among virtual objects 100 displayed on the display unit 4. For example, “L” can be acquired from an application in charge of drawing. Since “L” sometimes takes an extremely large value, it is preferable to provide an upper limit value for “L”.

In an example illustrated in the Expression (1), a value of the setting coefficient C increases as values of the respective parameters concerning the setting coefficient C are larger. Further, the value of the setting coefficient C increases as a value of the distance L is larger.

Note that the present invention is not limited to the example explained above. The setting coefficient C may be set as a constant to reduce a load in calculating the setting coefficient C. The setting coefficient C may be calculated using any one of the following (Expression 2) to (Expression 4).

[Math. 2]

C=L tan(Xr+Zr+Wr) (Expression 2)

[Math. 3]

C=Wt+L tan(Wr) (Expression 3)

[Math. 4]

C=Zt+L tan(Zr) (Expression 4)

In (Expression 2) described above, the setting coefficient C is a value indicating a degree of decrease in specifying accuracy based on rotation. In (Formula 3) described above, the setting coefficient C is a value indicating a degree of decrease in specifying accuracy based on a recognition error with respect to selection operation of a device that recognizes the selection operation. In (Equation 3) described above, the setting coefficient C is a value indicating a degree of deterioration in specifying accuracy based on an error of the user's selection operation.

The allocation unit 6c allocates the collider Dc having the size set by the setting unit 6b to the shielding mesh Dm. For example, the allocation unit 6c selects, from the collider storage unit 5c, the collider Dc having a size corresponding to the setting coefficient C set by the setting unit 6b and allocates the selected collider Dc to the shielding mesh Dm.

Consequently, the colliders Dc of different sizes are allocated to the shielding mesh Dm according to the specifying accuracy. The allocation unit 6c may generate the collider Dc based on the setting coefficient C and, then, allocate the generated collider Dc to the shielding mesh Dm.

The drawing unit 6d is, for example, a Graphics Processing Unit (GPU) and draws various content to be displayed on the display unit 4. For example, the drawing unit 6d draws the virtual object 100, the shielding mesh Dm, and the like as the various contents.

When the virtual object 100 is selected by the selection operation, the drawing unit 6d performs feedback by drawing. Examples of the feedback include a change of a display mode of the selected virtual object 100 and a change of drawing corresponding to a command associated with the virtual object 100. Note that the information processing apparatus 1 may perform the feedback using vibration or sound in addition to the drawing.

The detection unit 6e detects user's selection operation for the virtual object 100. For example, the detection unit 6e detects the user's finger by performing a predetermined image analysis for a video imaged by the outward camera 3a and detects the selection operation by the finger based on the detected finger. Note that, the detection unit 6e may detect the selection operation explained above from, for example, a video imaged by the user with a peripheral camera instead of the outward camera 3a.

The detection unit 6e detects the selection operation by the controller 3d based on, for example, information concerning the posture of the controller 3d input from the controller 3d. The detection unit 6e performs a predetermined image analysis for a video imaged by the inward camera 3b to detect the direction (the visual field) of the eyeballs of the user to detect selection operation by the visual line.

When detecting the selection operation, the detection unit 6e calculates operation information concerning a coordinate of a starting point of the detected selection operation and the direction of the selection operation and passes a calculation result to the specifying unit 6f.

The specifying unit 6f specifies a selected object, which is the virtual object 100, selected by the user based on the user's selection operation for the virtual object 100. The specifying unit 6f specifies the selected object based on the starting point of the selection operation and the direction of the selection operation detected by the detection unit 6e.

Specifically, the specifying unit 6f emits the ray R in the direction indicated by the selection operation from the starting point of the selection operation in the virtual space. The specifying unit 6f specifies, as the selected object, the virtual object 100 that collides with the ray R first.

More specifically, the specifying unit 6f calculates a collider that collides with the ray R first. At this time, when the collider colliding with the ray R first is allocated to the virtual object 100, the specifying unit 6f specifies the virtual object 100 as the selected object. When the collider colliding with the ray R first is allocated to the shielding mesh Dm, the specifying unit 6f invalidates the selection operation.

Accordingly, as illustrated in FIG. 2, even if the ray R collides with the shielding mesh Dm, if the ray R does not collide with the collider Dc, the ray R penetrates the shielding mesh Dm and collides with the shielding region where the virtual object 100 is shielded by the shielding mesh Dm. This can facilitate the user's selection operation for the virtual object 100.

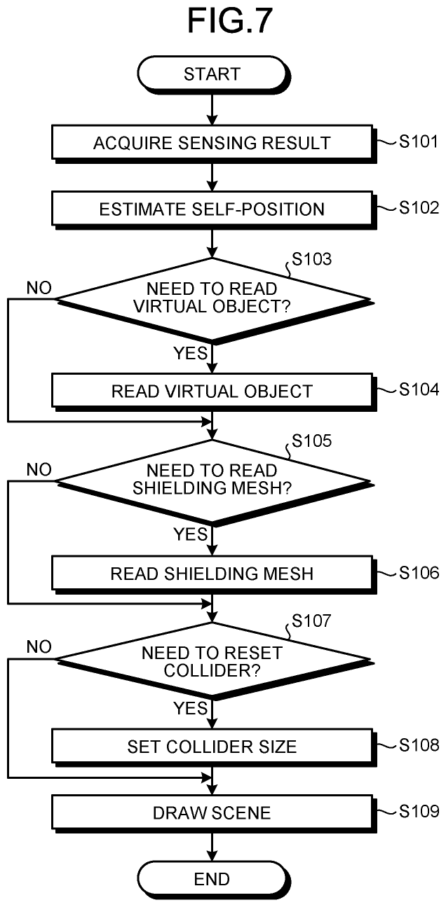

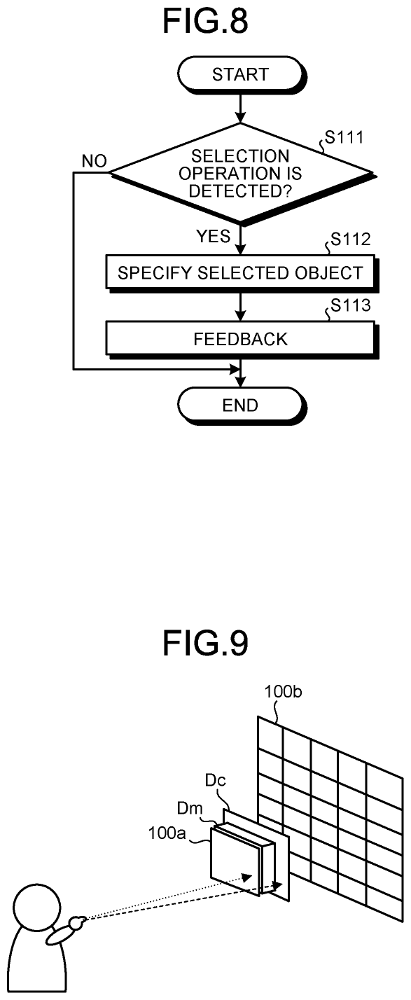

Next, a processing procedure executed by the information processing apparatus 1 according to the embodiment is explained with reference to FIG. 7 and FIG. 8. FIG. 7 and FIG. 8 are flowcharts illustrating the processing procedure executed by the information processing apparatus 1 according to the embodiment. Note that the processing procedure explained below is repeatedly executed by the control unit 6 of the information processing apparatus 1.

As illustrated in FIG. 7, when acquiring a sensing result of the sensor 3 (step S101), the information processing apparatus 1 estimates a self-position based on the sensing result (step S102). Note that, in the processing of step S102, correction of the self-position is also executed at a predetermined cycle.

Subsequently, the information processing apparatus 1 determines, based on the estimation result of the self-position estimation in step S102, whether it is necessary to read the virtual object 100 (step S103). When determining that it is necessary to read the virtual object 100 (step S103, Yes), the information processing apparatus 1 executes the reading of the virtual object 100 (step S104).

When determining that it is unnecessary to read the virtual object 100 (step S103, No), the information processing apparatus 1 proceeds to processing of step S105. Subsequently, the information processing apparatus 1 determines whether it is necessary to read the shielding mesh Dm (step S105). When determining that it is necessary to read the shielding mesh Dm (step S105, Yes), the information processing apparatus 1 executes the reading of the shielding mesh Dm (step S106).

When determining that it is unnecessary to read the shielding mesh Dm in the determination of step S105 (step S105, No), the information processing apparatus 1 proceeds to processing of step S107.

Subsequently, the information processing apparatus 1 determines whether resetting of the collider Dc allocated to the shielding mesh Dm is necessary (step S107). When determining that the resetting is necessary (step S107, Yes), the information processing apparatus 1 sets a size of the collider Dc (step S108).

When determining in the determination of step S107 that it is unnecessary to reset the collider Dc (step S107, No), the information processing apparatus 1 proceeds to processing of step S109. Thereafter, the information processing apparatus 1 draws a scene based on a processing result up to step S108 (step S109) and ends the processing.

Next, a series of processing procedures involved in the selection operation for the virtual object 100 is explained with reference to FIG. 8. Note that the processing procedure illustrated in FIG. 8 is executed in parallel with the processing procedure illustrated in FIG. 7. As illustrated in FIG. 8, the information processing apparatus 1 determines whether selection operation of the user for the virtual object 100 is detected (step S111). When the selection operation is detected (step S111, Yes), the information processing apparatus 1 specifies a selected object selected by the selection operation (step S112).

Subsequently, the information processing apparatus 1 executes feedback based on the selected object specified in step S112 (step S113) and ends the processing. When the selection operation is not detected in the determination of step S111 (step S111, No), the information processing apparatus 1 ends the processing as it is.

Incidentally, in the embodiment explained above, the case where the collider Dc allocated to the shielding mesh Dm is set small with respect to the shielding mesh Dm is explained. However, the present invention is not limited thereto. That is, the collider Dc allocated to the shielding mesh Dm may be set large with respect to the shielding mesh Dm.

Here, a specific example of such a point is explained with reference to FIG. 9. FIG. 9 is a schematic diagram illustrating a relationship between the shielding mesh Dm and the collider Dc. In FIG. 9, a case where a first virtual object 100a, the shielding mesh Dm, the collider Dc, and a second virtual object 100b are present when viewed from the user is illustrated.

In the example illustrated in FIG. 9, a case where the first virtual object 100a is set on the main surface of the shielding mesh Dm is illustrated. In a situation illustrated in FIG. 9, it is assumed that the first virtual object 100a and the shielding mesh Dm are relatively small and the second virtual object 100b is selected, although the user performs selection operation for the first virtual object 100a.

Accordingly, in the information processing apparatus 1, the collider Dc allocated to the shielding mesh Dm is set larger than the shielding mesh Dm. Consequently, a collider of the first virtual object 100a can be expanded and the selection operation for the first virtual object 100a can be facilitated.

Note that the information processing apparatus 1 may set the size of the collider Dc according to the setting coefficient C explained above. In this case, for example, the collider Dc is set larger as the setting coefficient C is larger. The size of the collider Dc may be set according to the size of the shielding mesh Dm (that is, the first virtual object 100a). In this case, as the shielding mesh Dm is smaller, it is harder to perform the selection operation. Therefore, the collider Dc is set larger.

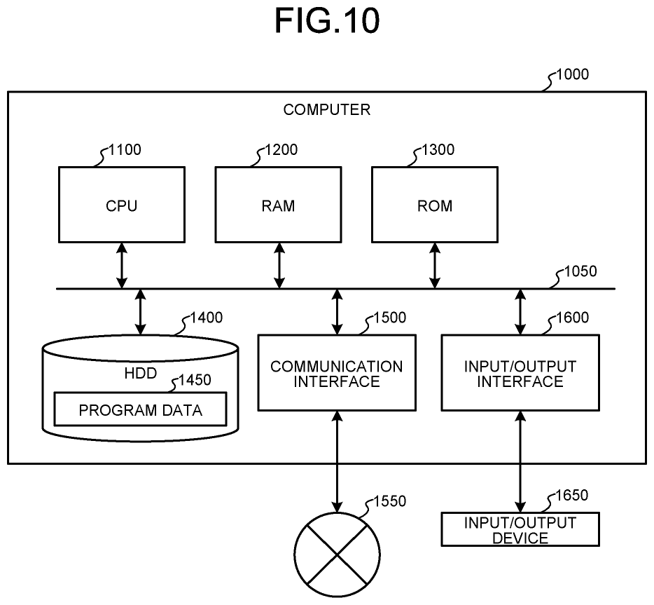

The information equipment such as the information processing apparatus according to the embodiments explained above is realized by, for example, a computer 1000 having a configuration as illustrated in FIG. 10. In the following explanation, the information processing apparatus 1 is explained as an example. FIG. 10 is a hardware configuration diagram illustrating an example of the computer 1000 that realizes the functions of the information processing apparatus 1. The computer 1000 includes a CPU 1100, a RAM 1200, a Read Only Memory (ROM) 1300, a Hard Disk Drive (HDD) 1400, a communication interface 1500, and an input/output interface 1600. The units of the computer 1000 are connected by a bus 1050.

The CPU 1100 operates based on programs stored in the ROM 1300 or the HDD 1400 and controls the units. For example, the CPU 1100 develops the programs stored in the ROM 1300 or the HDD 1400 in the RAM 1200 and executes processing corresponding to various programs.

The ROM 1300 stores a boot program such as a Basic Input Output System (BIOS) executed by the CPU 1100 at a start time of the computer 1000, a program depending on hardware of the computer 1000, and the like.

The HDD 1400 is a computer-readable recording medium that non-transiently records a program to be executed by the CPU 1100, data used by such a program, and the like. Specifically, the HDD 1400 is a recording medium that records an information processing program according to the present disclosure, which is an example of program data 1450.

The communication interface 1500 is an interface for the computer 1000 to be connected to an external network 1550 (for example, the Internet). For example, the CPU 1100 receives data from other equipment and transmits data generated by the CPU 1100 to the other equipment via the communication interface 1500.

The input/output interface 1600 is an interface for connecting an input/output device 1650 and the computer 1000. For example, the CPU 1100 receives data from an input device such as a keyboard or a mouse via the input/output interface 1600. The CPU 1100 transmits data to an output device such as a display, a speaker, or a printer via the input/output interface 1600. The input/output interface 1600 may function as a media interface that reads a program or the like recorded in a predetermined recording medium (a medium). The medium is, for example, an optical recording medium such as a Digital Versatile Disc (DVD) or a Phase change rewritable Disk (PD), a magneto-optical recording medium such as a Magneto-Optical Disk (MO), a tape medium, a magnetic recording medium, or a semiconductor memory.

For example, when the computer 1000 functions as the information processing apparatus 1, the CPU 1100 of the computer 1000 executes an information processing program loaded on the RAM 1200 to thereby realize the functions of the self-position estimation unit 6a and the like. In the HDD 1400, an information processing program according to the present disclosure, data in the storage unit 5, and the like are stored. Note that the CPU 1100 reads the program data 1450 from the HDD 1400 and executes the program data. However, as another example, the CPU 1100 may acquire these programs from another device via the external network 1550.

Note that the present technology can also take the following configurations.

(1)

An information processing apparatus comprising:

a setting unit that sets, in a virtual space displayed on a display unit, a collider for collision determination, which is allocated to mesh data indicating a shape of a real object present in a real world, to a size different from a size of the mesh data; and

an allocation unit that allocates the collider corresponding to the size set by the setting unit to the mesh data.

(2)

The information processing apparatus according to (1) described above, wherein the setting unit sets the collider small with respect to the mesh data.

(3)

The information processing apparatus according to (1) or (2) described above, wherein the setting unit sets a size of the mesh data based on a distance to the mesh data.

(4)

The information processing apparatus according to any one of (1) to (3) described above, further including a specifying unit that specifies a selected object, which is the virtual object selected by the user based on selection operation of the user for the virtual object.

(5)

The information processing apparatus according to (4) described above, wherein the specifying unit specifies, as the selected object, the virtual object that is present first in a direction of the selection operation from a starting point of the selection operation.

(6)

The information processing apparatus according to (4) or (5) described above, wherein the setting unit sets the collider allocated to the mesh data smaller than the mesh data when a part of the virtual object selectable by the selection operation is shielded by the mesh data.

(7)

The information processing apparatus according to (6) described above, wherein the setting unit sets a size of the collider based on specifying accuracy of the selected object by the specifying unit.

(8)

The information processing apparatus according to (6) (7) described above, wherein the setting unit sets the mesh data smaller as the specifying accuracy is lower.

(9)

The information processing apparatus according to any one of (6) to (8) described above, wherein the setting unit estimates the specifying accuracy based on a distance from a starting point of the selection operation in the real world to an eye of the user and sets a size of the collider based on the estimated specifying accuracy.

(10)

The information processing apparatus according to any one of (6) to (9) described above, wherein the setting unit

estimates the specifying accuracy based on detection accuracy of the selection operation and sets a size of the collider based on the estimated specifying accuracy.

(11)

The information processing apparatus according to any one of (6) to (10) described above, further comprising a self-position estimation unit that estimates a self-position in a real space and corrects the self-position at a predetermined cycle, wherein

the setting unit estimates the specifying accuracy based on a change amount of the self-position from the self-position after the correction and sets a size of the collider based on the estimated specifying accuracy.

(12)

The information processing apparatus according to (11) described above, wherein the setting unit estimates the specifying accuracy based on a moving distance from the self-position after the correction.

(13)

The information processing apparatus according to (11) or (12) described above, wherein the setting unit estimates the specifying accuracy based on a rotation amount from the self-position after the correction.

(14)

The information processing apparatus according to any one of (6) to (13) described above, wherein the setting unit estimates the specifying accuracy based on a vibration component of the selection operation and sets a size of the collider based on the estimated specifying accuracy.

(15)

The information processing apparatus according to any one of (1) to (14) described above, wherein the setting unit sets the collider larger than the mesh data.

(16)

The information processing apparatus according to (15) described above, wherein the setting unit sets the collider larger than the mesh data when the virtual object is associated with the mesh data.

(17)

The information processing apparatus according to any one of (1) to (16) described above, further comprising a storage unit that stores a plurality of the colliders having different sizes, wherein

the allocation unit selects, from the storage unit, the collider corresponding to the size set by the setting unit.

(18)

The information processing apparatus according to any one of (1) to (17) described above, wherein the allocation unit generates the collider having a size installed by the setting unit.

(19)

An information processing method comprising a computer:

setting, in a virtual space displayed on a display unit, a collider for collision determination, which is allocated to mesh data indicating a shape of a real object present in a real world, to a size different from a size of the mesh data; and

allocating the collider corresponding to the set size to the mesh data.

(20)

An information processing program for causing a computer to function as:

a setting unit that sets, in a virtual space displayed on a display unit, a collider for collision determination, which is allocated to mesh data indicating a shape of a real object present in a real world, to a size different from a size of the mesh data; and

an allocation unit that allocates the collider corresponding to the size set by the setting unit to the mesh data.

### REFERENCE SIGNS LIST

1 INFORMATION PROCESSING APPARATUS
3 SENSOR
3a OUTWARD CAMERA
3b INWARD CAMERA
3c 9 dof SENSOR
3d CONTROLLER
3e POSITIONING UNIT
4 DISPLAY UNIT
5a MAP INFORMATION STORAGE UNIT
5b MESH DATA STORAGE UNIT
5c COLLIDER STORAGE UNIT
6a SELF-POSITION ESTIMATION UNIT
6b SETTING UNIT
6c ALLOCATION UNIT
6d DRAWING UNIT
6e DETECTION UNIT
6f SPECIFYING UNIT
100 VIRTUAL OBJECT
C SETTING COEFFICIENT
Dc COLLIDER
Dm SHIELDING MESH (CORRESPONDING TO MESH DATA)
R RAY (EXAMPLE OF VIRTUAL RAY)

1. An information processing apparatus comprising:
a setting unit that sets, in a virtual space displayed on a display unit, a collider for collision determination, which is allocated to mesh data indicating a shape of a real object present in a real world, to a size different from a size of the mesh data; and
an allocation unit that allocates the collider corresponding to the size set by the setting unit to the mesh data.

2. The information processing apparatus according to claim 1, wherein the setting unit sets the collider small with respect to the mesh data.

3. The information processing apparatus according to claim 1, wherein the setting unit sets a size of the mesh data based on a distance to the mesh data.

4. The information processing apparatus according to claim 1, further comprising a specifying unit that specifies a selected object, which is the virtual object selected by the user based on user's selection operation for the virtual object present in the virtual space.

5. The information processing apparatus according to claim 4, wherein the specifying unit emits a virtual ray in a direction of the selection operation from a starting point of the selection operation and specifies, as the selected object, the virtual object with which the ray collides first.

6. The information processing apparatus according to claim 4, wherein the setting unit sets the collider allocated to the mesh data smaller than the mesh data when a part of the virtual object selectable by the selection operation is shielded by the mesh data.

7. The information processing apparatus according to claim 5, wherein the setting unit sets a size of the collider based on specifying accuracy of the selected object by the specifying unit.

8. The information processing apparatus according to claim 7, wherein the setting unit sets the mesh data smaller as the specifying accuracy is lower.

9. The information processing apparatus according to claim 7, wherein the setting unit estimates the specifying accuracy based on a distance from a starting point of the selection operation in the real world to an eye of the user and sets a size of the collider based on the estimated specifying accuracy.

10. The information processing apparatus according to claim 7, wherein the setting unit estimates the specifying accuracy based on recognition accuracy of the selection operation and sets a size of the collider based on the estimated specifying accuracy.

11. The information processing apparatus according to claim 7, further comprising a self-position estimation unit that estimates a self-position in a real space and corrects the self-position at a predetermined cycle, wherein
the setting unit estimates the specifying accuracy based on a change amount of the self-position from the self-position after the correction and sets a size of the collider based on the estimated specifying accuracy.

12. The information processing apparatus according to claim 11, wherein the setting unit estimates the specifying accuracy based on a moving distance from the self-position after the correction.

13. The information processing apparatus according to claim 11, wherein the setting unit estimates the specifying accuracy based on a rotation amount from the self-position after the correction.

14. The information processing apparatus according to claim 7, wherein the setting unit estimates the specifying accuracy based on a vibration component of the selection operation and sets a size of the collider based on the estimated specifying accuracy.

15. The information processing apparatus according to claim 4, wherein the setting unit sets the collider larger than the mesh data.

16. The information processing apparatus according to claim 14, wherein the setting unit sets the collider larger than the mesh data when the virtual object is associated with the mesh data.

17. The information processing apparatus according to claim 1, further comprising a storage unit that stores a plurality of the colliders having different sizes, wherein
the allocation unit selects, from the storage unit, the collider corresponding to the size set by the setting unit.

18. The information processing apparatus according to claim 1, wherein the allocation unit generates the collider having the size set by the setting unit.

19. An information processing method comprising a computer:
setting, in a virtual space displayed on a display unit, a collider for collision determination, which is allocated to mesh data indicating a shape of a real object present in a real world, to a size different from a size of the mesh data; and
allocating the collider corresponding to the set size to the mesh data.

20. An information processing program for causing a computer to function as:
a setting unit that sets, in a virtual space displayed on a display unit, a collider for collision determination, which is allocated to mesh data indicating a shape of a real object present in a real world, to a size different from a size of the mesh data; and
an allocation unit that allocates the collider corresponding to the size set by the setting unit to the mesh data.
